(19) United States
(12) Patent Application Publication
(10) Pub. No.: US 2017/0124671 A1
(43) Pub. Date: May 4, 2017

(54) SYSTEMS AND METHODS FOR TRANSIT-RELATED TRANSACTIONS

(71) Applicant: TRANSPORTATION TECHNOLOGY PARTNERS L.L.C., Chicago, IL (US)

(72) Inventors: Chung Chung Tam, Naperville, IL (US); Michael Svanascini, Chicago, IL (US); John Perkaus, Winnetka, IL (US)

(21) Appl. No.: 15/343,155

(22) Filed: Nov. 3, 2016

Related U.S. Application Data
(60) Provisional application No. 62/250,285, filed on Nov. 3, 2015.

(51) Int. Cl. G06Q 50/14; G06Q 20/04; G06F 3/0482; G06Q 10/02

(52) U.S. Cl. CPC G06Q 50/14; G06Q 10/02; G06Q 20/0453; G06F 3/0482; G06F 3/0346

(57) ABSTRACT

A device for transit-related transactions includes processor(s) that control a user interface to send/receive information to/from a user and control a communication interface to communicate wirelessly with one or more external systems. The device includes storage device(s) storing data and program instructions. The program instructions cause the processor(s) to execute a ticketing procedure for a selected transit service. The ticketing procedure includes: receiving a ticket purchase request from the user; processing payment for the ticket purchase request; and storing an electronic ticket associated with the ticket purchase request after payment approval. The ticketing procedure may include establishing wireless communications with a ticketing system associated with the selected transit service; and in response to the payment approval, receiving the electronic ticket from the ticketing system. The ticketing procedure may also include receiving a ticket activation request from the user; and presenting the electronic ticket via the user interface for validation.

### CROSS-REFERENCE TO RELATED APPLICATIONS

This application claims priority to and benefit from U.S. Provisional Patent Application No. 62/250,285, filed on Nov. 3, 2015, the contents of which are incorporated entirely herein by reference.

### BACKGROUND

Field

The present disclosure relates generally to systems and methods for processing transit-related transactions, and more particularly, to systems and methods employing a mobile application for fare payment, trip planning, marketing, information exchange, and/or other transactions relating to the use of one or more transit services.

Description of Related Art

Travelers or commuters may have access to any combination of transit services for transportation to desired locations. Some transit services may employ automobile, bus, rail, airplane, boat, bicycle, other vehicle types, walking path, among other possibilities. Some transit services may also require some type of fare payment.

### SUMMARY

According to aspects of the present disclosure, systems and methods provide features for fare payment, trip planning, marketing, information exchange, and other transactions in connection with the use of one or more transit services.

According to an example embodiment, a device for transit-related transactions, includes one or more processors. The device includes a user interface coupled to the one or more processors. The one or more processors control the user interface to send information to a user or to receive input from the user. The device includes a communication interface coupled to the one or more processors. The one or more processors control the communication interface to communicate wirelessly with one or more external systems. The device includes one or more storage devices coupled to the one or more processors and storing data and program instructions. The program instructions cause the one or more processors to execute a ticketing procedure for a selected transit service. The ticketing procedure includes receiving, via the user interface, a ticket purchase request from the user. The ticketing procedure includes processing payment for the ticket purchase request. The ticketing procedure includes storing, on the one or more storage devices, an electronic ticket associated with the ticket purchase request after approval of the payment.

In some cases, the ticketing procedure further includes establishing wireless communications, via the communication interface, with a ticketing system associated with the selected transit service. The ticketing procedure further includes, in response to the approval of the payment, receiving, via the communication interface, the electronic ticket from the ticketing system.

In other cases, the ticketing procedure further includes receiving, via the user interface, a ticket activation request from the user, and in response to the ticket activation request, presenting the electronic ticket via the user interface for validation.

In yet other cases, the program instructions further cause the one or more processors to execute a trip planning procedure. The trip planning procedure includes receiving, via the user interface, destination information from the user. The trip planning procedure includes determining one or more travel plans for transporting the user according to the destination information, each travel plan designating one or more transit services. The trip planning procedure includes presenting, via the user interface, the one or more travel plans to the user.

The trip planning procedure above may further include receiving, via the user interface, a selection of one of the travel plans. The trip planning procedure may include, in response to the selection of one of the travel plans, identifying the corresponding one or more transit services associated with the selected travel plan requiring a ticket. The trip planning procedure may include prompting, via the user interface, the user to select one of the transit services requiring a ticket and to make the ticket purchase request for the selected transit service. The ticketing procedure correspondingly receives the ticket purchase request.

Additionally, the program instructions may further cause the one or more processors to execute a purchase procedure for goods or services of one or more third parties. The purchase procedure includes presenting, via the user interface, one or more offers for goods or services from respective third parties according to the selected travel plan. The purchase procedure includes receiving, via the user interface, a selection of one of the offers by the user. The purchase procedure includes, in response to the selection of one of the offers, establishing wireless communication, via the communication interface, with the respective third party. The purchase procedure includes sending to the respective third-party vendor, via the communication interface, a purchase request based on the selected offer. The purchase procedure includes processing payment for the purchase request based on the selected offer.

### BRIEF DESCRIPTION OF THE DRAWINGS

FIG. 1 illustrates an example system for processing transit-related transactions, according aspects of the present disclosure.

FIG. 2 illustrates an example ticketing procedure relating to transit-related transactions, according to aspects of the present disclosure.

FIG. 3 illustrates an example trip planning procedure relating to transit-related transactions, according to aspects of the present disclosure.

FIG. 4 illustrates an example purchase procedure for goods or services from one or more third-party vendors, according to aspects of the present disclosure.

### DETAILED DESCRIPTION

According to aspects of the present disclosure, systems and methods provide features for fare payment, trip planning, marketing, information exchange, and other transactions in connection with the use of one or more transit services. In general, transit services can transport one or more individuals to one or more destinations along one or more transit routes via automobile, bus, rail, airplane, boat, bicycle, other vehicle types, walking path, among other possibilities. Some transit services, such as public bus and/or rail service, may be provided by government agencies. Other transit services, such as taxi or car service, may be provided by private providers. Some of these transit services may require the payment of fares by their users.

According to example embodiments, systems and methods employ a travel mobile application (TMA) to provide a user with information regarding one or more transit services to one or more destinations according to preferences indicated by the user. In addition, the TMA may provide fare information for the one or more travel plans, collect fare payment for a selected transit service, and provide the user with electronic ticket(s) for the selected travel plan. The TMA may provide various approaches for activating and validating the electronic ticket(s) for use along the selected transit service. For example, one approach allows the user to activate an electronic ticket by shaking the mobile device where an accelerometer triggers activation by the TMA. Once activated, the electronic ticket can be validated by presenting visual and/or aural indicators to travel service personnel via the mobile device.

Also, the TMA may dynamically alert the user regarding changes to the one or more transit routes and allow the user to revise the user's travel plans. Moreover, the TMA may enhance the user's travel by providing information regarding points of interest and services available to the user along the one or more transit routes. Further, the TMA may provide offers (e.g., electronic coupons) for products and services from third-party vendors along the one or more transit routes to encourage the user's patronage during the user's travel. The TMA may also accept advance payment for products and services to expedite the transactions with third-party vendors along a selected travel route and limit delays during the user's travel. In general, the TMA may provide a payment platform for services that extend beyond just the travel services to accommodate other user activity (e.g., dining at a restaurant, running errands, etc.) during travel. Other features and/or variations for the TMA are contemplated and described herein.

The TMA provides computer executable instructions for execution by a mobile device, such as a smart phone, smart device, digital assistant, tablet computer, or other portable computing device. In some cases, the TMA may be implemented in a customized portable computing device, which may have highly portable and convenient form factors, such as a configuration to be worn about the wrist or neck. The TMA may be stored on a computer-readable storage device, e.g., non-volatile memory, on the mobile device. When executing the instructions, the mobile device may present audiovisual content on a user interface, receive and process data received from a user via the user interface, communicate with one or more external systems (e.g., server, cloud, etc.) over a network connection (e.g., WIFI™, cellular, BLUETOOTH®, near field communications, etc.), process and present data from the one or more external systems on the user interface, etc. The TMA can process and integrate data from a plurality of sources and present such data in a user-friendly manner via the user interface. The TMA may be employed as one aspect of a system for providing transit services.

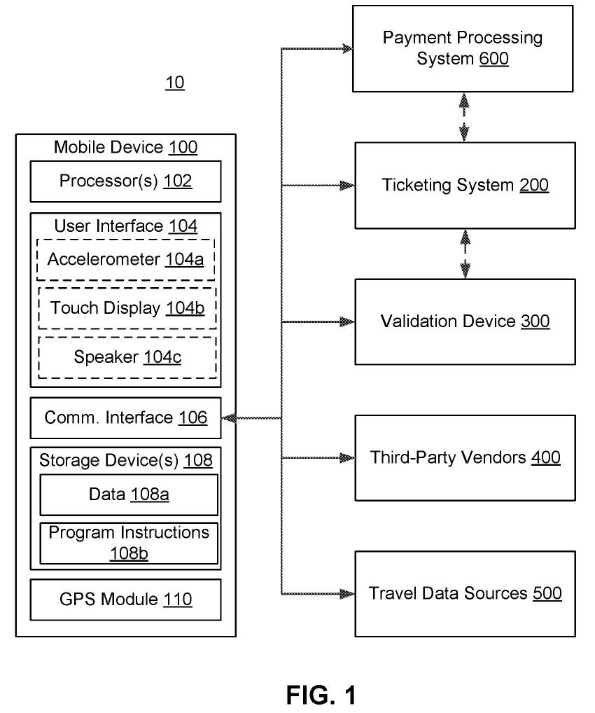

FIG. 1 illustrates an example system 10 for implementing systems and methods for transit-related transactions. The example system includes a mobile device 100. The mobile device 100 includes one or more processors 102. The processor(s) 102 are coupled to a user interface 104, a communication interface 106, and one or more computer-readable storage devices 108. The processor(s) 102 control the user interface 104 to present information to a user and/or receive input from the user. The processor(s) 102 control the communication interface 106 to communicate wirelessly with one or more external systems (e.g., via WIFI™, cellular, BLUETOOTH®, near field communications, etc.). The storage device(s) 108 store data 108a and program instructions 108b. The processor(s) 102 may execute the program instructions 108b to provide features of the TMA.

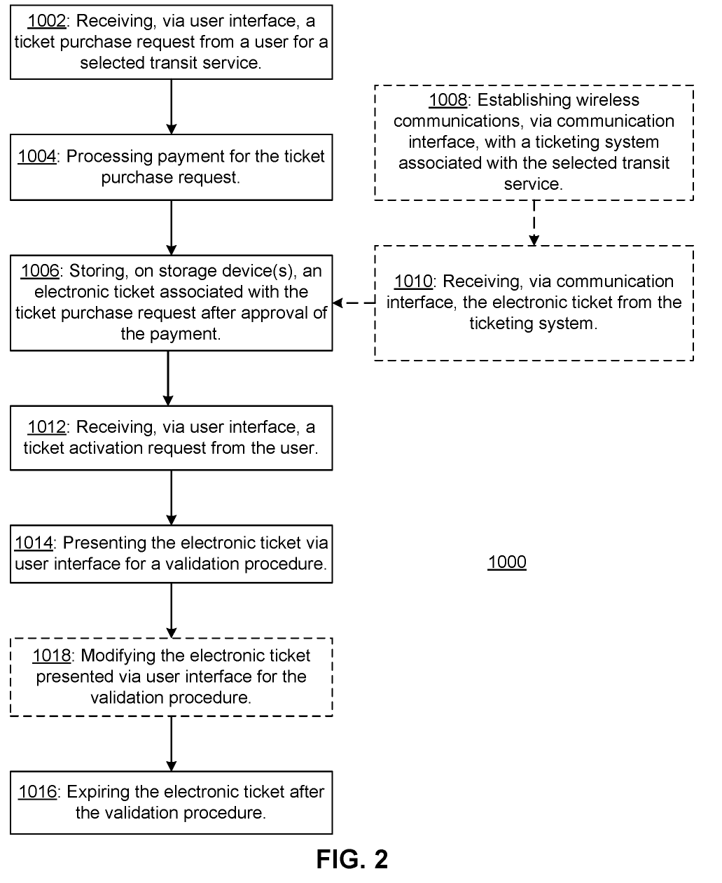

In particular, the program instructions 108b may cause the processor(s) 102 to execute a ticketing procedure for a selected transit service. FIG. 2 illustrates an example ticketing procedure 1000, which may include at least acts 1002, 1004, 1006. Act 1002 involves receiving, via the user interface 104, a ticket purchase request from a user for the selected transit service. For instance, the selected transit service may be passenger rail service and the user may want to purchase a ticket to board a train. Act 1004 involves processing payment for the ticket purchase request. Act 1006 involves storing, on the storage device(s) 108, an electronic ticket associated with the ticket purchase request after approval of the payment. As used herein, a ticket is anything (e.g., employing text, graphic, symbols, video, sound, other indicator, etc.) that can be presented or otherwise evaluated to provide a user with access to a transit service. Payment, e.g., of a fare, may be required to obtain a ticket.

The ticketing procedure 1000 may further include acts 1008, 1010. Act 1008 involves establishing wireless communications, via the communication interface 106, with a ticketing system 200 associated with the selected transit service. Act 1010 involves receiving, via the communication interface 106, the electronic ticket from the ticketing system 200. The ticketing system 200 is shown in FIG. 1 and may be a server system, e.g., on the cloud, that is maintained by the provider of the selected transit service, e.g., government bus and/or rail agency, to handle the sale and distribution of tickets. Alternatively, the ticketing system 200 may be a server system maintained by an independent third party, e.g., online travel agency, to handle the sale and distribution of tickets for any number/combination of transit services.

As shown in FIG. 2, the ticketing procedure 1000 may further include acts 1012, 1014, 1016. Act 1012 involves receiving, via the user interface 104, a ticket activation request from the user. The ticket activation prepares the stored electronic ticket for actual use by the user to access the selected transit service. Act 1014 involves presenting the electronic ticket via the user interface 104 for a validation procedure. Moreover, the ticketing procedure 1000 may include act 1016 which involves expiring the electronic ticket after the validation procedure. The validation procedure may be completed with a validation device 300 as shown in FIG. 1. The validation device 300 is employed to evaluate the electronic ticket to confirm that the user is permitted to use the selected transit service, e.g., by providing proper payment.

According to some embodiments, the user interface 104 may include an accelerometer 104a for motion input from the user. As such, the user can shake the mobile device 100 so that the accelerometer 104a triggers activation of the electronic ticket. Thus, receiving the ticket activation request in act 1012 may include detecting, with the accelerometer 104a, the motion input from the user.

Additionally or alternatively, the user interface 104 may include a touch screen 104b for touch input from the user. Correspondingly, receiving the ticket activation request in act 1012 may include detecting, via the touch display 104b, the touch input from the user.

According to some embodiments, the electronic ticket may be presented at least visually on the touch display 104b. For instance, the electronic ticket may be presented visually as a barcode, e.g., two-dimensional barcode, on the touch display 104b. The barcode can include various types of embedded information relating to the electronic ticket. For instance, the embedded information may indicate where and when the electronic may be used. As described above, a validation device 300 may be employed to evaluate the electronic ticket. Here, the validation device 300 may be an optical barcode scanner. Thus, if the selected transit service is a municipal bus system, the bus driver may operate the validation device 300 to scan the barcode.

Additionally or alternatively, the electronic ticket may be presented visually as a video, e.g., animated video, on the touch display 104b. Additionally or alternatively, the user interface 104 includes a speaker 104c and the electronic ticket is presented at least aurally via the speaker 104c.

According to some embodiments, the ticketing procedure 1000 may further include act 1018 which involves modifying the electronic ticket presented via the user interface 104 for the validation procedure. The user may provide a corresponding modification request via the user interface 104. The modification may allow the electronic ticket to be more effectively evaluated for the validation procedure. Modifying the electronic ticket may include modifying a size of the electronic ticket presented at least visually on the touch display 104b. Alternatively, modifying the electronic ticket may include modifying a playback of the electronic ticket presented as a video on the touch display 104b. Alternatively, modifying the electronic ticket may include modifying a volume of the electronic ticket presented at least aurally via the speaker 104c.

Additionally or alternatively, the processor(s) 102 detect, via the communication interface 106, a wireless activation signal associated with the selected transit service. For instance, if the user boards a bus, the bus may have communication equipment that transmits the wireless activation signal. Accordingly, the ticketing procedure 2000 may further include acts (not shown) which involves detecting, via the communication interface 106, the wireless activation signal, and presenting the electronic ticket via the user interface for the validation procedure, in response to the wireless activation signal.

In some embodiments, the program instructions 108b further cause the processor(s) 102 to receive, via the user interface 104, user account information from the user. The user account information includes payment information for the payment of the ticket purchase request. The processor(s) 102 store the user account information as data 108a on the storage device(s) 108. Correspondingly, processing payment for the ticket purchase request in act 1004 may include establishing wireless communications, via the communication interface 106, with a payment processing system 600 as shown in FIG. 1. Processing payment in act 1004 may also include sending, via the communication interface 106, the payment information to the payment processing system 600, where the payment processing system 600 determines the approval of the payment for the ticker purchase request. Processing payment in act 1004 may further include receiving, via the communication interface 106, the approval of the payment for the ticker purchase request from the payment processing system 600.

In alternative embodiments, the program instructions 108b may further cause the processor(s) 102 to send, via the communications interface 106, the user account information 108 to the ticketing system 200 which stores the user account information. Correspondingly, processing payment for the ticket purchase request in act 1004 may include establishing wireless communications, via the communication interface 106, with the ticketing system 200. Processing payment in act 1004 may also include sending, via the communication interface 106, a request to the ticketing system 200 for approval of the payment for the ticker purchase request. The ticketing system 200, instead of the mobile device 100, may communicate with the payment processing system 600 to determine the approval of the payment according to the payment information. Accordingly, the ticketing procedure 1000 may further include an act 1024 which involves receiving from the ticketing system 200, via the communication interface 106, the electronic ticket associated with the ticket purchase request.

In some embodiments, the ticketing system 200 may provide centralized control of aspects of the ticketing procedure 1000. For instance, the ticketing system 200 may store user accounts for a plurality of users and may handle payments for and distribution of electronic tickets for the plurality of users.

Validation of the electronic ticket can be achieved according to any number of approaches. In some cases, transit service personnel may manually evaluate visual and/or aural indicators associated with the electronic ticket and presented via the user interface 104. In other cases, transit service personnel may employ a validation device 300 to electronically evaluate (e.g., optically scan) the electronic ticket presented via the user interface 104. If the electronic ticket is received from the ticketing system 200, the validation device 300 may communicate with the ticketing system 200 to validate the electronic ticket and/or to update the ticketing system 200 on the use of the electronic ticket.

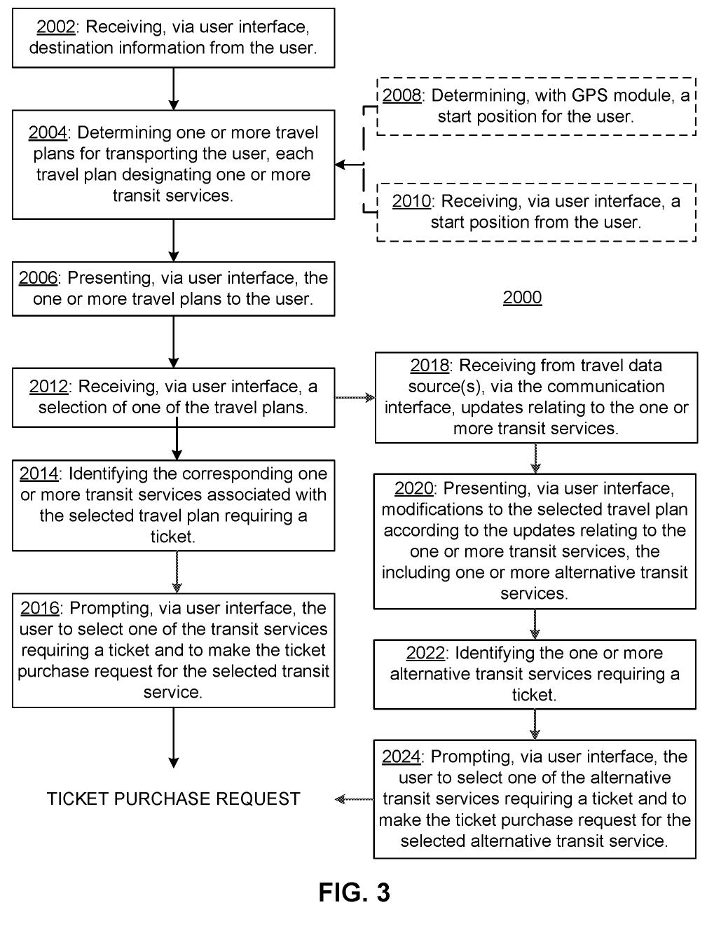

In some embodiments, the program instructions 108b further cause the processor(s) to execute a trip planning procedure 2000 as shown in FIG. 3. The trip planning procedure 2000 may include acts 2002. 2004, 2006. Act 2002 involves receiving, via the user interface 106, destination information from the user. Act 2004 involves determining one or more travel plans for transporting the user according to the destination information. Each travel plan may designate one or more transit services that direct the user along one or more routes to the desired destination(s). For instance, to get to a destination, one of the travel plans may call for riding a bus over a first route, walking for a second route, and riding a train for a third route. Act 2006 involves presenting, via the user interface 106, the one or more travel plans to the user.

The mobile device 100 may have a global positioning system (GPS) module 110. Accordingly, the trip planning procedure 2000 may also include act 2008 which involves determining, with the GPS module 110, a start position for the user, and the one or more travel plans is further determined according to the start position. Additionally or alternatively, the trip planning procedure 2000 includes act 2010 which involves receiving, via the user interface 104, a start position from the user, and the one or more travel plans is further determined according to the start position.

As also shown in FIG. 3, the trip planning procedure 2000 may further include acts 2012, 2014, 2016. Act 2012 involves receiving, via the user interface 104, a selection of one of the travel plans. In response to the selection of one of the travel plans, act 2014 involves identifying the corresponding one or more transit services associated with the selected travel plan requiring a ticket. Additionally, act 2016 involves prompting, via the user interface 104, the user to select one of the transit services requiring a ticket and to make the ticket purchase request for the selected transit service. The ticketing procedure 1000 described above correspondingly receives the ticket purchase request.

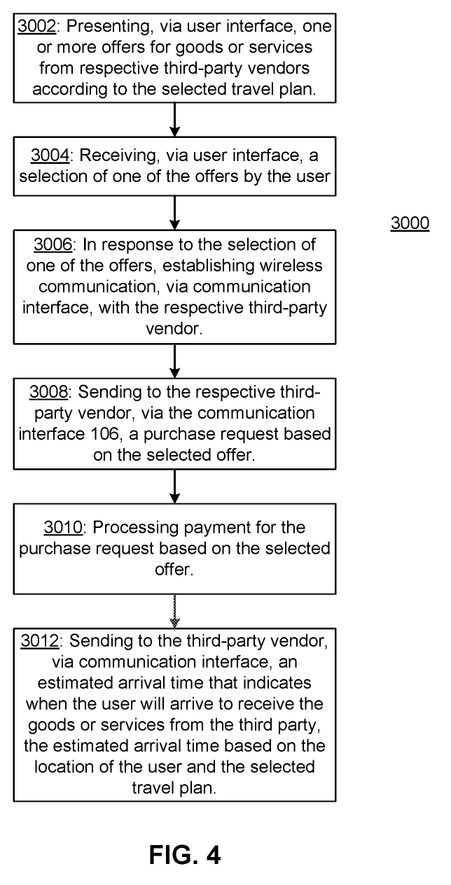

In some embodiments, the program instructions 108b further cause the processor(s) to execute a purchase procedure 3000 for goods or services from one or more third-party vendors 400 as shown in FIG. 1. As FIG. 4 illustrates, the purchase procedure 3000 may include acts 3002, 3004, 3006, 3008, 3010. Act 3002 involves presenting, via the user interface 104, one or more offers for goods or services from respective third-party vendors according to the selected travel plan. In particular, by following the selected travel plan, the user may find himself/herself in the vicinity of a third-party vendor, which may have goods or services of interest to the user. For instance, a coffee shop may be located along one of the routes of the selected travel plan, and the mobile device 100 allows the user to make an advanced purchase of a cup of coffee during the user's commute. Correspondingly, act 3004 involves receiving, via the user interface 104, a selection of one of the offers by the user. In response to the selection of one of the offers, act 3006 involves establishing wireless communication, via the communication interface 106, with the respective third-party vendor. Act 3008 involves sending to the respective third-party vendor, via the communication interface 106, a purchase request based on the selected offer. For instance, the third-party vendor may have a computing device that electronically receives information to process the user's purchase request. Act 3010 involves processing payment for the purchase request based on the selected offer.

In some embodiments, the program instructions 108b may further cause the processor(s) 102 to determine a location of the user relative to the selected travel plan. Correspondingly, the purchase procedure 3000 may further include act 3012 which involves sending to the third-party vendor, via the communication interface 106, an estimated arrival time that indicates when the user will arrive to receive the goods or services from the third-party vendor. The estimated arrival time is based on the location of the user as well as the selected travel plan. Advantageously, the user can avoid delays in receiving the purchased goods and services and the third-party vendor can optimize its operations based on the estimated arrival time.

The location of the user may be determined with the GPS module 110. Alternatively, the program instructions 108b may further cause the processor(s) 102 to establish wireless communication, via the communication interface 106, with one or more travel data sources 500 associated with the corresponding one or more transit services associated with the selected travel plan. The travel data sources 500 are shown in FIG. 1. Additionally, the processor(s) 102 may also receive, via the communication interface 106, updates relating to the one or more transit services, and determine the location of the user according to updates relating to the one or more transit services. For instance, the estimated arrival time for a user may be affected by unexpected delays in rail service.

As described above, the program instructions 108b may further cause the processor(s) 102 to receive, via the user interface 104, user account information from the user and store the user account information in the storage device(s) 108. In some embodiments, the user account information includes trip planning preferences. The one or more travel plans may be further determined or presented according to the trip planning preferences.

In some embodiments, the trip planning procedure 2000 may further include acts 2018, 2020, 2022, 2024. Act 2018 involves receiving from the one or more travel data sources 500, via the communication interface 106, updates relating to the one or more transit services, and act 2020 which involves presenting, via the user interface 104, modifications to the selected travel plan according to the updates relating to the one or more transit services. The modifications to the selected travel plan may include one or more alternative transit services. Correspondingly, act 2022 includes identifying the one or more alternative transit services requiring a ticket. Act 2024 involves prompting, via the user interface 104, the user to select one of the alternative transit services requiring a ticket and to make the ticket purchase request for the selected alternative transit service. The ticketing procedure 1000 described above correspondingly receives the ticket purchase request.

In view of the foregoing, any of the following example features may be combined to provide a TMA according to aspects of the present disclosure:
1. User Account Setup
   a. Creation of a single user profile for the TMA, which may be linked to other mobile applications:
      i. Login name
      ii. Password
      iii. E-mail address
      iv. Security Questions
      v. Name of user
      vi. Address (home, work, etc.)
      vii. Phone numbers
      viii. Payment information
      ix. Pace of walking/biking (slow, medium, fast, etc.)
      x. Any special needs (use wheelchair, walker, guide dog, etc.)
   b. Unique User Filter Settings
      i. Contact preferences: email, text, phone call, video conferencing, social media, etc.
      ii. Preferences for travel plans: shortest route, fastest route, least expensive route, route with fewest transfer points, earliest arrival/departure, latest arrival/departure, less walking, greenest route (less gas usage, air pollution, etc. per person/vehicle), etc.
      iii. Preferences for mode of transportation: bus, subway, light rail, commuter rail, public on-demand, ferry, taxi, private car, car-share, bike-share, etc.
      iv. Preferences for routes: select or avoid local road, highway, express lane, HOV lane, bridge, tunnel, tollway, bike lane, etc.
      v. Different preferences can be set up and saved, with particular preferences being designated as a default.
      vi. Favorites:
         1. Enter current/start location, destination, start date/time, and arrival date/time for regular or one-time travel; such information can be imported from contact information or electronic calendar, such as GOOGLE® Calendar or OUTLOOK® Calendar.
         2. Enter your shopping preferences, such as preferred coffee shops, bakeries, restaurants, department stores, home improvement stores, sports venues, theaters, etc.
   c. Payment Information
      i. Choice of payment can be set up manually based on business categories or store names, such as purchasing air tickets using airlines issued credit card, paying for shopping using store issued credit card, etc.
      ii. Payment instruments: credit card, debit card, PAYPAL, GOOGLE® WALLET, APPLE® PAY, SAMSUNG® PAY, MERCHANT CUSTOMER EXCHANGE (MCX) CURRENTC, NFC, FELICA, BPAY, closed-loop smartcard, private-label cards, etc.
      iii. Fare or any payment can be prepaid through TMA or link to other payment processor application.
      iv. Multiple payment methods can be set up for convenient accounting (e.g., business vs. personal expenses).
      v. History of payment transactions can be tracked and displayed on the TMA.
   d. Interface Setup
      i. Voice command enable/disable
   e. Alert & Notification Setup
      i. Travel delays, re-routes, schedule changes, wheel-chair accessibility, road closed, road detour, operating hours, accident, etc.
      ii. To remind a user when/how to transfer from different mode of transportation
   f. Permission & Allowance
      i. Share current location
      ii. GPS enable/disable
      iii. Alert/Notification enable/disable
      iv. Advertisement/Mobile Coupon enable/disable
2. Interface to a Local or User Selected Trip Planner
   a. Based on the GPS information and partnership agreement(s), approved trip planner applications are available for selection.
   b. The TMA can provide a user turn-by-turn walking directions.
   c. Transit pricing data is available is used to calculate the fare according to the modes of transportation. Fares may be flat fares or zone-based/distance-based fares.
   d. The TMA interfaces with the selected trip planner application and populates fields in the trip planner application with data from the user profile and filters.
   e. The TMA also calculates the fare required for each recommended route.
   f. The TMA recommends a list of routes based on user preferences with the associated pricing.
   g. The TMA can tell the user how much time is available before the next scheduled departure (e.g., train, bus, tram, etc.) and the estimated time to reach the departure point; this allows the user to know if there is time to conduct other activities and the TMA can present marketing material and other information regarding such activities, e.g., an electronic coupon that encourages the user to visit a store or restaurant prior to the scheduled departure.
   h. The TMA can present the routes based on the preferences for travel (Section 1.c.ii)
   i. Once a route is identified and pricing is calculated, the TMA provides a list of preferred routes with different fare options, and prompts the user for fare payment. The TMA is configured to handle prepaid, post-paid, or no charge depends on the fare categories (adult, child, student, senior, corporate account, etc.).
   j. After the payment is accepted, an electronic ticket is stored on the device pending activation. This electronic ticket can be activated even if the device is off-line. On-line connection is required only for data transmission via wireless communication.
   k. The ticket types, expiration date/time, etc. are programmable and downloadable from a cloud server to the mobile device, and such information is visible and retrievable whether the mobile phone is on or off-line once the purchase is complete.
   l. In some cases, the user may attempt to use a transit service, e.g., board a bus, without a prepaid ticket. For the user's convenience and to avoid any delays that may occur by forcing the user to conduct a payment transaction via the TMA, e.g., during the boarding process, the TMA may allow the user to use the transit service and defer the payment transaction to a later time. In effect, the TMA is used as a token. To allow such use, the user may be required to have a user account, e.g., with the transit service, and some associated payment method, e.g., credit card, so that the payment transaction can be conducted in the background.
   m. For use of services, e.g., bike-sharing, car-sharing, etc., in a trip plan, a loyalty program may be employed to provide loyalty points and to prioritize reservations for services, e.g., loyalty points can be earned by using selected services to attain different reward/reward levels, and a greater number of points gives higher priority for use and selection of the shared services (bike, car, etc.) among other rewards.
   n. The TMA can estimate arrival time for a leg of the trip by calculating a pace from the distance and amount of already travelled (e.g., by walking, biking, etc.) in the leg and applying the pace to the remaining distance in the leg.
   o. A user may indicate an estimated pace (slow, medium, fast, etc.) prior to starting a leg of the trip (e.g., by walking, biking, etc.) and the TMA can estimate an arrival time by applying the estimated pace to the distance of the leg.
3. Activation of a Ticket
   a. Once the valid ticket is available, the user can tap the screen, press the HOME button, and/or shake the mobile device a few times to activate the ticket. Shaking the mobile device causes the accelerometer of the mobile device to trigger the TMA to activate the ticket. This feature may be particularly convenient as the user is not required to provide keyed input via the user interface. In addition, the user can interrupt other functionality or applications on the mobile device by shaking the mobile device and causing the TMA running in the background to activate the ticket.
   b. Various visual and/or aural indications can be provided via the user interface to signal ticket activation and to allow transit service personnel to validate the ticket, e.g.:
      i. A video, e.g., animated graphics, can be displayed
      ii. 2-D barcode or QR Code can be displayed utilizing high contrast and different color schemes, and other features to enhance visibility and security
      iii. An embedded security code can be displayed
      iv. An alert, sound or speech can be played during the activation
      v. Using pressure sensitive touch screen:
         1. With increasing touch pressure, a video is played with increasing playback speed.
         2. With increasing touch pressure, audio is played with increasing volume.
         3. With increasing touch pressure, text such as a security code is displayed with increasing size.
   c. Additionally, automatic validation may occur via NFC technology.
   d. The TMA can also display advertising while engaging or not engaging in ticketing functions.
4. Advanced Purchase from Third-Party Vendors
   a. The TMA provides offers for products and services from vendors along a selected route to encourage the user's patronage during the user's travel. Additionally, the mobile application can accept advance payment for products and services to expedite the transactions with businesses and limit delays during the user's travel.
   b. Interface to payment mechanism if needed.
   c. Once the product or service has been prepaid, user can go straight to the “prepaid” counter to obtain the product or service. There is no need to wait in line to order and make the payment. For example, if there is a coffee shop along the user's route, the user may use the TMA to place an advance order for a cup of coffee including prepayment, so that the coffee shop can prepare the cup of coffee in advance and the user can pick up the cup of coffee, e.g., from a designated counter, without delay.
   d. A prepaid order is prepared and can be picked up at “the prepaid” counter based on the arrival time for the bus, train, car, bike, walk, etc. as planned by the trip planner.
   e. When any changes to the trip itinerary, notification can be sent to both the user and business to either adjust or cancel the order. Credit or refund can be provided to the passenger based on a user agreement.
   f. Payment can be done on any mobile devices with or without account set up.
   g. Additionally, a payment account for the vendor(s) may be established where funds may be added to the payment account via the TMA or at the vendor's location, e.g., for payment by cash.
   h. Validation of purchase can be done similar to Section 3, e.g., a secured barcode or an order number may be displayed on the mobile device to verify and pick up the order.
   i. A computer tablet or similar device with appropriate software may be employed at the business location to receive and fulfill orders.
      i. The software running on the business device may fulfill/prioritize orders based on different considerations, not necessarily based on the sequence of order receipt, e.g., amount of time required to make/prepare the order, expected arrival of customer, any changes to customer's trip itinerary, e.g., travel disruptions
      ii. The software may provide communications between business and customer via email, text, etc., e.g., in case order is modified, delayed, cannot be fulfilled, etc.
      iii. The software may allow the business to manage an order in case there are changes to the customer's trip itinerary, e.g., travel disruptions. The software may show a list of pending orders and highlight any orders that are impacted by such changes and provides a menu of options for response by the business when a highlighted order is selected via the user interface.
      iv. The software may display a count-down clock to show how much time is left to fill an order. The software may display a list of pending orders which may be color-coded to alert the business and expedite orders, e.g., GREEN=on time/lower priority; ORANGE=start filling the order; RED=critical/little time left to fill order). The list may also use blinking text/color to indicate order is ready or delayed.
      v. The software may display a count-up clock to show the time elapsed from the expected pick up time.
      vi. The software may include a threshold setting to notify the business when an order is spoiled due to a delay in the order pick up and provides a menu of options for response by the business. For instance, if the business is filling an order for coffee, any significant delay may result in undesired cooling of the coffee.
      vii. The business device may be coupled with one or more overhead display/monitor (LCD/LED) to communicate the status of orders to customers, e.g., (“Ready,” “In Progress,” “Order Not Filled”). The display may provide an order number or customer initials to identify the order and may indicate the estimated pick up time calculated from the estimated arrival time based on the customer's trip itinerary. The one or more monitors may reduce order status inquiries by customers.
5. Smart in handling Delays/Cancellations
   a. The TMA can obtain info about delays/cancellations from each individual agency (BART, Caltrain, CTA, VTA, etc.).
   b. The TMA can notify the user when/how to transfer between transit options and/or what alternatives are available if train/tram/bus is delayed/cancelled or if traveler misses a departure time due to traffic, etc.
   c. The TMA can suggest alternatives if delay/cancellation is prohibitive with respect to user's goals.
   d. The TMA can suggest a taxi/ride service/rental car and can use APIs of those services to automatically order a taxi/UBER/LYFT/rental car if desired.
   e. The TMA can get compensation from transit providers for hardship/inconvenience of delay/cancellation.
   f. The TMA can try to bargain/negotiate with transit service providers for replacement travel options based on hardship from the delay/cancellation. For example, transit service providers may extend the time limit for the use of tickets to accommodate any delays.
6. Special needs Settings
   a. If user is disabled (e.g., permanently wheelchair-bound), user can check a setting to ensure that all suggestions by the TMA are wheelchair-accessible transit methods and/or limit inconveniences (e.g., limit “walking” sections as much as possible)
   b. The TMA can send customized special accommodation requests based on agency/disability (e.g., request special type of taxicab/car service, request an assistant from transit service to help lift wheelchair into vehicle, or request that a wheelchair space be cleared on vehicle train ahead of time).
7. Advertisement Settings
   a. ON/OFF, with OFF setting appropriately placed on screen
   b. Advertisers—location-based coupons (e.g., coffee, beer)
   c. Food preferences—e.g., vegetarians shouldn't get ads for steak
   d. Allergies—e.g., don't advertise peanut butter to people with peanut allergy
   e. Coupons/rewards—e.g., reward TMA users with a free coffee/beer/meal just for using the app
   f. Rewards budget comes out of the commission earnings from TMA
8. Handling of Exception Cases
   a. The TMA focuses on what happens when traveler is late to station, when train is delayed/cancelled, or generally what happens when something goes wrong
   b. The TMA provides real-time trip planning updates—notify traveler in real-time when they should be transferring trains, etc.
9. Data Sources for Travel Data
   a. Provided by local transit agencies and 3^{rd} party entities through data feeds includes static schedule and service data using an open standard, and APIs which has the up-to-the-minute information.
   b. Also customer Alerts API that is a feed of both planned and unplanned events that affect service may be published by the transit agencies and 3rd party entities.
   c. Any administrative and configuration data, such as fare table, etc. may be stored on a cloud server.

Although the examples above may refer to a mobile application on a mobile device, it is understood that aspects of the present disclosure may be implemented as any type of application on any type of computing device. Such devices may be GPS-enabled or GPS-disabled. Furthermore, aspects of the present disclosure may be implemented on additional devices or systems. For instance, the TMA may optionally communicate with one or more external servers that provide additional processing and/or data storage. In some cases, a SaaS/cloud server-based service may be employed as a data repository.

As described above, according to some aspects of the present disclosure, some or all of the steps of the above-described and illustrated procedures can be automated or guided under the control of a combination of processing hardware and software elements. The hardware aspects may include combinations of operatively coupled hardware components including microprocessors, logical circuitry, communication/networking ports, digital filters, memory, or logical circuitry. The hardware elements may be adapted to perform operations specified by a computer-executable code, which may be stored on a computer readable medium. In general, physical processors and/or machines employed by embodiments of the present disclosure for any processing or evaluation may include one or more networked or non-networked general purpose computer systems, microprocessors, field programmable gate arrays (FPGA's), digital signal processors (DSP's), micro-controllers, and the like, programmed according to the teachings of the example embodiments of the present disclosure, as is appreciated by those skilled in the computer and software arts.

Appropriate software can be readily prepared by programmers of ordinary skill based on the teachings of the example embodiments, as is appreciated by those skilled in the software art. In addition, the devices and subsystems of the example embodiments can be implemented by the preparation of application-specific integrated circuits or by interconnecting an appropriate network of conventional component circuits, as is appreciated by those skilled in the electrical art(s). Thus, the example embodiments are not limited to any specific combination of hardware circuitry and/or software.

Stored on any one or on a combination of computer readable media, the example embodiments of the present disclosure may include software for controlling the devices and subsystems of the example embodiments, for driving the devices and subsystems of the example embodiments, for enabling the devices and subsystems of the example embodiments to interact with a human user, and the like. Such software can include, but is not limited to, device drivers, firmware, operating systems, development tools, applications software, and the like. Such computer readable media further can include the computer program product of an embodiment of the present disclosure for performing all or a portion (if processing is distributed) of the processing performed in implementations. Computer code devices of the example embodiments of the present disclosure can include any suitable interpretable or executable code mechanism, including but not limited to scripts, interpretable programs, dynamic link libraries (DLLs), Java classes and applets, complete executable programs, and the like. Moreover, parts of the processing of the example embodiments of the present disclosure can be distributed for better performance, reliability, cost, and the like.

Common forms of computer-readable media may include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present disclosure has been described with reference to one or more particular embodiments, those skilled in the art will recognize that many changes may be made thereto without departing from the spirit and scope of the present disclosure. Each of these embodiments and obvious variations thereof is contemplated as falling within the spirit and scope of the invention. It is also contemplated that additional embodiments according to aspects of the present disclosure may combine any number of features from any of the embodiments described herein.

What is claimed is:

1. A device for transit-related transactions, comprising:
one or more processors;
a user interface coupled to the one or more processors, the one or more processors controlling the user interface to send information to a user or to receive input from the user;
a communication interface coupled to the one or more processors, the one or more processors controlling the communication interface to communicate wirelessly with one or more external systems;
one or more storage devices coupled to the one or more processors and storing data and program instructions, the program instructions causing the one or more processors to execute a ticketing procedure for a selected transit service, the ticketing procedure including:
receiving, via the user interface, a ticket purchase request from the user;
processing payment for the ticket purchase request; and
storing, on the one or more storage devices, an electronic ticket associated with the ticket purchase request after approval of the payment.

2. The device according to claim 1, wherein the ticketing procedure further includes:
establishing wireless communications, via the communication interface, with a ticketing system associated with the selected transit service; and
in response to the approval of the payment, receiving, via the communication interface, the electronic ticket from the ticketing system.

3. The device according to claim 1, wherein the ticketing procedure further includes:
receiving, via the user interface, a ticket activation request from the user; and
in response to the ticket activation request, presenting the electronic ticket via the user interface for validation.

4. The device according to claim 3, wherein the ticketing procedure further includes expiring the electronic ticket after the validation.

5. The device according to claim 3, wherein the user interface includes an accelerometer for motion input from the user, and receiving the ticket activation request via the user interface includes detecting, with the accelerometer, the motion input.

6. The device according to claim 3, wherein the user interface includes a touch display for touch input from the user, and receiving the ticket activation request via the user interface includes detecting, via the touch screen, the touch input.

7. The device according to claim 3, wherein the user interface includes a display and the electronic ticket is presented at least visually on the display.

8. The device according to claim 3, wherein the user interface includes a speaker and the electronic ticket is presented at least aurally via the speaker.

9. The device according to claim 3, wherein the ticketing procedure further includes, in response to receiving, via the user interface, a modification request from the user, modifying the electronic ticket presented via the user interface for validation.

10. The device according to claim 1, wherein the one or more processors are configured to detect, via the communication interface, a wireless activation signal associated with the transit service, and the ticketing procedure further includes:
detecting, via the communication interface, the wireless activation signal; and
in response to the wireless activation signal, presenting the electronic ticket via the user interface for validation.

11. The device according to claim 1, wherein the program instructions further cause the one or more processors to:
receive, via the user interface, user account information from the user, the user account information including payment information for the payment of the ticket purchase request; and
store the user account information on the one or more storage devices,
wherein processing payment for the ticket purchase request includes:
establishing wireless communications, via the communication interface, with a payment processing system;
sending, via the communication interface, the payment information to the payment processing system, the payment processing system determining the approval of the payment for the ticker purchase request; and
receiving, via the communication interface, the approval of the payment for the ticker purchase request from the payment processing system.

12. The device according to claim 1, wherein the program instructions further cause the one or more processors to:
receive, via the user interface, user account information from the user, the user account information including payment information for the payment of the ticket purchase request;
store the user account information in the one or more storage devices;
send, via the communications interface, the user account information to a ticketing system associated with the selected transit service, the ticketing system storing the user account information,
wherein processing payment for the ticket purchase request includes:
establishing wireless communications, via the communication interface, with the ticketing system; and
sending, via the communication interface, a request to the ticketing system for approval of the payment for the ticker purchase request, the ticketing system determining the approval of the payment according to the payment information; and
wherein the ticketing procedure further includes receiving from the ticketing system, via the communication interface, the electronic ticket associated with the ticket purchase request.

13. The device according to claim 1, wherein the program instructions further cause the one or more processors to execute a trip planning procedure including:
receiving, via the user interface, destination information from the user;
determining one or more travel plans for transporting the user according to the destination information, each travel plan designating one or more transit services; and
presenting, via the user interface, the one or more travel plans to the user.

14. The device according to claim 13, wherein the trip planning procedure further includes:
receiving, via the user interface, a selection of one of the travel plans;
in response to the selection of one of the travel plans, identifying the corresponding one or more transit services associated with the selected travel plan requiring a ticket; and
prompting, via the user interface, the user to select one of the transit services requiring a ticket and to make the ticket purchase request for the selected transit service, and
wherein the ticketing procedure correspondingly receives the ticket purchase request.

15. The device according to claim 14, wherein the program instructions further cause the one or more processors to execute a purchase procedure for goods or services of one or more third parties, the purchase procedure including:
presenting, via the user interface, one or more offers for goods or services from respective third parties according to the selected travel plan;
receiving, via the user interface, a selection of one of the offers by the user;
in response to the selection of one of the offers, establishing wireless communication, via the communication interface, with the respective third party;
sending to the respective third-party vendor, via the communication interface, a purchase request based on the selected offer; and
processing payment for the purchase request based on the selected offer.

16. The device according to claim 15, wherein the program instructions further cause the one or more processors to determine a location of the user relative to the selected travel plan, and the purchase procedure further includes sending to the third party, via the communication interface, an estimated arrival time that indicates when the user will arrive to receive the goods or services from the third party, the estimated arrival time based on the location of the user and the selected travel plan.

17. The device according to claim 16, wherein the program instructions further cause the one or more processors to:
establish wireless communication, via the communication interface, with one or more travel data sources associated with the corresponding one or more transit services associated with the selected travel plan;
receiving, via the communication interface, updates relating to the one or more transit services, and
determine the location of the user according to updates relating to the one or more transit services.

18. The device according to claim 13, wherein the program instructions further cause the one or more processors to:
receive, via the user interface, user account information from the user, the user account information including trip planning preferences; and
store the user account information in the one or more storage devices, and
wherein the one or more travel plans are further determined or presented according to the trip planning preferences.

19. The device according to claim 13, wherein the trip planning procedure further includes:
receiving, via the user interface, a selection of one of the travel plans;
in response to the selection of one of the travel plans, identifying the corresponding one or more transit services associated with the selected travel plan;
establishing wireless communication, via the communication interface, with one or more travel data sources associated with the corresponding one or more transit services;
receiving, via the communication interface, updates relating to the one or more transit services, and
presenting, via the user interface, modifications to the selected travel plan according to the updates relating to the one or more transit services.

20. The device according to claim 19, wherein the modifications to the selected travel plan include one or more alternative transit services, and the trip planning procedure further includes:
identifying the one or more alternative transit services requiring a ticket;
prompting, via the user interface, the user to select one of the alternative transit services requiring a ticket and to make the ticket purchase request for the selected alternative transit service, and
wherein the ticketing procedure correspondingly receives the ticket purchase request.
